(19) United States
(12) Patent Application Publication
(10) Pub. No.: US 2026/0249389 A1
(43) Pub. Date: Aug. 27, 2026

(54) LASER PROCESSING DEVICE, LASER PROCESSING METHOD, AND RECOVERY MECHANISM

(71) Applicant: MITSUBISHI HEAVY INDUSTRIES, LTD., Tokyo (JP)

(72) Inventors: Shigetoshi Shiotani, Tokyo (JP); Jiro Yoneda, Tokyo (JP); Ryuichi Narita, Tokyo (JP); Saneyuki Goya, Tokyo (JP); Shin Asano, Tokyo (JP); Atsushi Sugiura, Tokyo (JP)

(73) Assignee: MITSUBISHI HEAVY INDUSTRIES, LTD., Tokyo (JP)

(21) Appl. No.: 18/875,898

(22) PCT Filed: Aug. 22, 2023
(86) PCT No.: PCT/JP2023/030141

§ 371 Date: Dec. 17, 2024

(30) Foreign Application Priority Data
Sep. 20, 2022 (JP) 2022-148923

(51) Int. Cl. B23K 26/142; B23K 26/14

(52) U.S. Cl. CPC B23K 26/142; B23K 26/1476

(57) ABSTRACT

A laser processing device includes: a laser head that irradiates a workpiece with laser light; and a recovery mechanism that recovers a product generated by the irradiation with the laser light. The recovery mechanism includes a first recovery unit that includes a first air supply nozzle that supplies a scavenging gas and a first suction duct that is provided to face the first air supply nozzle, and a second recovery unit that includes a second air supply nozzle that supplies the scavenging gas and a second suction duct that is provided to face the second air supply nozzle.

### TECHNICAL FIELD

The present disclosure relates to a mechanism for recovering products such as fume, spatter, and the like inevitably generated by irradiation with laser light (light amplification by stimulated emission of radiation), and a laser processing device including the recovery mechanism.

### BACKGROUND ART

In a case where a workpiece is processed by irradiating the workpiece with laser light, dust and smoke, which are referred to as fume and spatter, are inevitably generated. Since a product such as the fume is a hindrance to laser processing, the product such as the fume is recovered. In order to recover the product such as the fume, as disclosed in PTL 1 and PTL 2, air or other gases are supplied to a processed part, and the processed portion is decompressed and suctioned.

In a case where the laser light is emitted to cut, for example, a workpiece, a laser head that emits the laser light is moved along a required trajectory. In a case where the dimension of the workpiece in a thickness direction is large, the workpiece cannot be completely cut by irradiating the workpiece with the laser light only once along the trajectory. Therefore, the laser head may be reciprocated to irradiate the workpiece with the laser light along the trajectory a plurality of times.

### CITATION LIST

### Patent Literature

[PTL 1] Japanese Unexamined Patent Application Publication No. 2007-021574
[PTL 2] Japanese Unexamined Patent Application Publication No. 10-225788

### SUMMARY OF INVENTION

### Technical Problem

An object of the present disclosure is to provide a laser processing device capable of efficiently recovering a product even in a case where a laser head is reciprocated.

### Solution to Problem

A laser processing device according to the present disclosure includes a laser head that irradiates a workpiece with laser light, and a recovery mechanism that recovers a product generated by the irradiation with the laser light. The recovery mechanism includes a first recovery unit and a second recovery unit. The first recovery unit includes a first air supply nozzle that supplies a scavenging gas and a first suction duct that is provided to face the first air supply nozzle. The second recovery unit includes a second air supply nozzle that supplies the scavenging gas and a second suction duct that is provided to face the second air supply nozzle.

In the laser processing method of irradiating a workpiece with laser light from the laser head of the present disclosure, the first recovery step and the second recovery step are selectively performed.

In the first recovery step, a scavenging gas is supplied from a first air supply nozzle, and the scavenging gas including a product generated by the irradiation with the laser light is suctioned through the first suction duct.

In the second recovery step, the scavenging gas is supplied from a second air supply nozzle, and the scavenging gas including the product is suctioned through the second suction duct.

### Advantageous Effects of Invention

The present disclosure includes the first recovery unit having the first air supply nozzle and the first suction duct, and the second recovery unit having the second air supply nozzle and the second suction duct. According to the present disclosure, for example, since the first recovery unit is used for recovering the product in the forward path and the second recovery unit is used for recovering the product in the backward path, the recovery unit functioning in each of the forward path and the backward path is provided, and thus the product can be efficiently recovered.

### BRIEF DESCRIPTION OF DRAWINGS

FIG. 1 is a diagram showing a main part of a laser processing device according to an embodiment.

FIG. 2 is a diagram showing a recovery mechanism of the laser processing device according to the embodiment.

FIG. 3 is a diagram showing a state in which a laser processing head reciprocates.

FIG. 4 is a diagram showing a recovery operation of the laser processing device according to the embodiment.

FIG. 5 is a diagram showing a main part of a laser processing device according to a first modification example.

FIG. 6 is a diagram showing a main part of a laser processing device according to a second modification example.

FIG. 7 is a diagram showing an operation of the laser processing device according to the second modification example.

FIG. 8 is a diagram showing a main part of a laser processing device according to a third modification example.

FIG. 9 is a diagram showing an operation of the laser processing device according to a third modification example.

FIG. 10 is a diagram showing an example of disposition of a first recovery unit and a second recovery unit included in the present disclosure.

### DESCRIPTION OF EMBODIMENTS

Hereinafter, an embodiment of a laser processing device 1 according to the present disclosure will be described with reference to the accompanying drawings.

The laser processing device 1 includes a laser head 10 that emits laser light, and a recovery mechanism 30 that recovers a product such as fume. The recovery mechanism 30 includes a set of a first air supply nozzle 32 and a first suction duct 33 and a set of a second air supply nozzle 36 and a second suction duct 37. In a case where the laser head 10 reciprocates in a forward path and a backward path to process a workpiece W, for example, one set of the first air supply nozzle 32 and the first suction duct 33 functions when the laser head 10 moves in the forward path, and the other set of the second air supply nozzle 36 and the second suction duct 37 functions when the laser head 10 moves in the backward path. Hereinafter, the laser processing device 1 will be described in the order of configuration, operation, and effect.

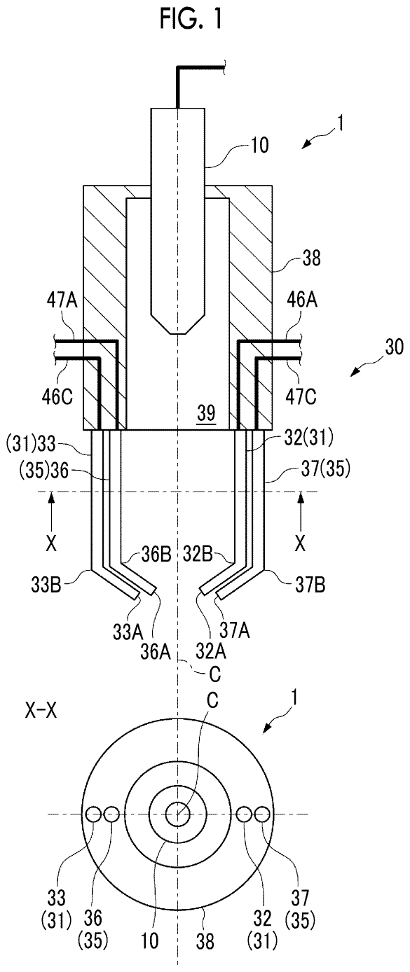

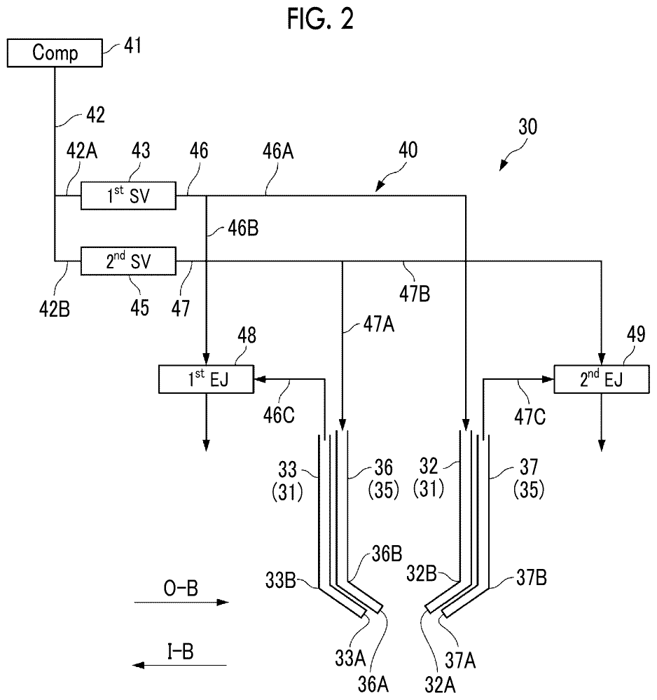

### [Configuration Example of Laser Processing Device 1: Refer to FIGS. 1 and 2]

As shown in FIGS. 1 and 2, the laser processing device 1 includes the laser head 10 and the recovery mechanism 30.

### [Laser Head 10: Refer to FIG. 1]

The laser head 10 emits laser light LB generated by a laser oscillator (not shown) to focus on the surface of the workpiece W. As the laser oscillator, for example, a fiber laser output device that outputs a laser using an optical fiber as a medium, a short-pulse laser output device that outputs a short-pulse laser, or the like is used. In addition, an optical system including a lens and a prism, and other devices are applied between the laser oscillator and the laser head 10.

### [Recovery Mechanism 30: Refer to FIGS. 1 and 2]

The recovery mechanism 30 includes, for example, a first recovery unit 31 that functions during processing on the forward path, and a second recovery unit 35 that functions during processing on the backward path, for example. The first recovery unit 31 and the second recovery unit 35 have the same components, but the disposition of the components differs by 180 degrees. The recovery mechanism 30 includes a scavenging unit 40 that supplies the scavenging gas to the first recovery unit 31 and the second recovery unit 35 and discharges the supplied scavenging gas together with the product such as fume from the processed part.

The first recovery unit 31 includes a first air supply nozzle 32 that supplies the scavenging gas such as an inert gas to the processed part, and a first suction duct 33 that discharges the scavenging gas including the product from the processed part. The first air supply nozzle 32 and the first suction duct 33 are disposed at symmetrical positions with the laser head 10 interposed therebetween and with respect to an axis C, that is, at positions shifted by 180 degrees in phase. This disposition is an example of the most preferable facing disposition. However, even in a case where scavenging can be performed, for example, the phases are shifted by about 150 degrees, the disposition is included in the facing disposition of the present disclosure.

The first air supply nozzle 32 includes an air supply port 32A at a tip thereof, and the first suction duct 33 includes a suction port 33A at a tip thereof. In addition, a bent portion 32B is formed near the tip of the first air supply nozzle 32, and a bent portion 33B is formed near the tip of the first suction duct 33. The bent portion 32B and the bent portion 33B are bent toward the axis C such that the air supply port 32A of the first air supply nozzle 32 and the suction port 33A of the first suction duct 33 face each other.

The second recovery unit 35 includes a second air supply nozzle 36 that supplies the scavenging gas such as an inert gas to the processed part, and a second suction duct 37 that discharges the scavenging gas including the product from the processed part. The second air supply nozzle 36 and the second suction duct 37 are disposed at symmetrical positions with the laser head 10 interposed therebetween and with respect to the axis C, that is, at positions shifted by 180 degrees in phase.

The second air supply nozzle 36 includes an air supply port 36A at a tip thereof, and the second suction duct 37 includes a suction port 37A at a tip thereof. In addition, a bent portion 36B is formed near the tip of the second air supply nozzle 36, and a bent portion 37B is formed near the tip of the second suction duct 37. The bent portion 36B and the bent portion 37B are bent toward the axis C such that the air supply port 36A of the second air supply nozzle 36 and the suction port 37A of the second suction duct 37 face each other.

The first air supply nozzle 32 and the second suction duct 37 are disposed side by side with the first air supply nozzle 32 on the inner side in a radial direction and the second suction duct 37 on the outer side in the radial direction. The second air supply nozzle 36 and the first suction duct 33 are disposed side by side with the second air supply nozzle 36 on the inner side in the radial direction and the first suction duct 33 on the outer side in the radial direction. The radial direction here is a direction with respect to an imaginary circle centered on the axis C.

The first recovery unit 31 and the second recovery unit 35 are supported by a support cylinder 38 fixed to the laser head 10. The laser head 10 is disposed in a laser passage 39 including a gap that occupies the center of the support cylinder 38, and the workpiece W (not shown) is irradiated with the laser light LB emitted from the tip of the laser head 10 through the laser passage 39. The first recovery unit 31 (first air supply nozzle 32 and first suction duct 33) and the second recovery unit 35 (second air supply nozzle 36 and second suction duct 37) are suspended from a lower end portion of the support cylinder 38, for example. A first air supply pipe 46A, a first suction pipe 46C, a second air supply pipe 47A, and a second suction pipe 47C constituting the scavenging unit 40 are connected to the first air supply nozzle 32, the first suction duct 33, the second air supply nozzle 36, and the second suction duct 37 via the support cylinder 38.

### [Scavenging Unit 40: Refer to FIGS. 2 and 1]

The scavenging unit 40 scavenges air containing a product such as fume and other gases using the recovery mechanism 30. Here, the scavenging means performing both of the air supply for supplying gas and the suction of the gas. In the following, an example in which compressed air is used as the scavenging gas will be described, but other gases, for example, an inert gas can also be used as the scavenging gas.

The scavenging unit 40 includes a compressor 41, and a first solenoid valve 43 and a second solenoid valve 45 that supply and stop compressed air supplied from the compressor 41. The compressor 41 and the first solenoid valve 43 and the second solenoid valve 45 are connected by a basic pipe 42 that is branched into a branch pipe 42A and a branch pipe 42B from the middle, and the compressed air from the compressor 41 passes through the basic pipe 42 and reaches the first solenoid valve 43 and the second solenoid valve 45.

One end of a first scavenging pipe 46 is connected to the first solenoid valve 43, and one end of a second scavenging pipe 47 is connected to the second solenoid valve 45. The other end of the first scavenging pipe 46 is connected to the first recovery unit 31, and the other end of the second scavenging pipe 47 is connected to the second recovery unit 35.

The first scavenging pipe 46 is branched into a first air supply pipe 46A and a first compressed air supply pipe 46B. The first air supply pipe 46A is connected to the first air supply nozzle 32, and the first compressed air supply pipe 46B is connected to a first ejector 48. The ejector refers to a mechanical element that forms a decompressed (vacuum) space by allowing compressed air to flow therein.

In a case where the compressed air from the compressor 41 is supplied to the first air supply pipe 46A via the first solenoid valve 43, the compressed air is discharged from the air supply port 32A of the first air supply nozzle 32 toward the processed part.

One end of the first suction pipe 46C is connected to the first ejector 48, and the other end of the first suction pipe 46C is connected to the first suction duct 33. In a case where the compressed air from the compressor 41 is supplied to the first ejector 48, the inside of the first suction pipe 46C connected to the decompressed first ejector 48 is set to a reduced pressure atmosphere, and thus the first suction duct 33 suctions the surrounding air including a product such as fume from the suction port 33A. The air containing the suctioned product is recovered in a container such as a tank, which is not shown, via the first ejector 48.

The second scavenging pipe 47 is branched into a second air supply pipe 47A and a second compressed air supply pipe 47B. The second air supply pipe 47A is connected to the second air supply nozzle 36, and the second compressed air supply pipe 47B is connected to a second ejector 49.

In a case where the compressed air from the compressor 41 is supplied to the second air supply pipe 47A via the second solenoid valve 45, the compressed air is discharged from the air supply port 36A of the second air supply nozzle 36.

One end of the second suction pipe 47C is connected to the second ejector 49, and the other end of the second suction pipe 47C is connected to the second suction duct 37. In a case where the compressed air from the compressor 41 is supplied to the second ejector 49, the inside of the second suction pipe 47C connected to the decompressed second ejector 49 is set to a reduced pressure atmosphere, and thus the second suction duct 37 suctions the surrounding air including the product such as fume from the suction port 37A. The air containing the suctioned product is recovered in a container such as a tank, which is not shown, via the second ejector 49.

In the scavenging unit 40, the first solenoid valve 43 and the second solenoid valve 45 are selectively opened and closed in accordance with whether the processing of the workpiece W by the laser head 10 is performed on the forward path or the backward path. That is, in a case where the forward path is processed, for example, the first solenoid valve 43 is opened (ON) and the second solenoid valve 45 is closed (OFF). In this case, the compressed air is supplied to the first air supply nozzle 32 via the first air supply pipe 46A, and the compressed air is supplied to the first ejector 48 via the first compressed air supply pipe 46B, and thus, the scavenging is performed. In addition, in a case where the backward path is processed, the second solenoid valve 45 is opened (ON) and the first solenoid valve 43 is closed (OFF). In this case, the compressed air is supplied to the second air supply nozzle 36 via the second air supply pipe 47A, and the compressed air is supplied to the second ejector 49 via the first compressed air supply pipe 46B, and thus, the scavenging is performed.

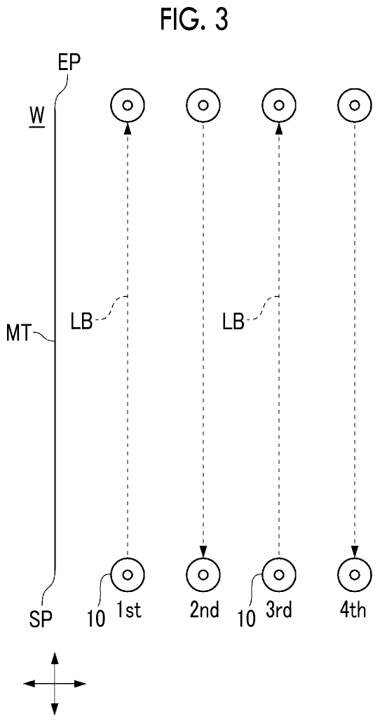

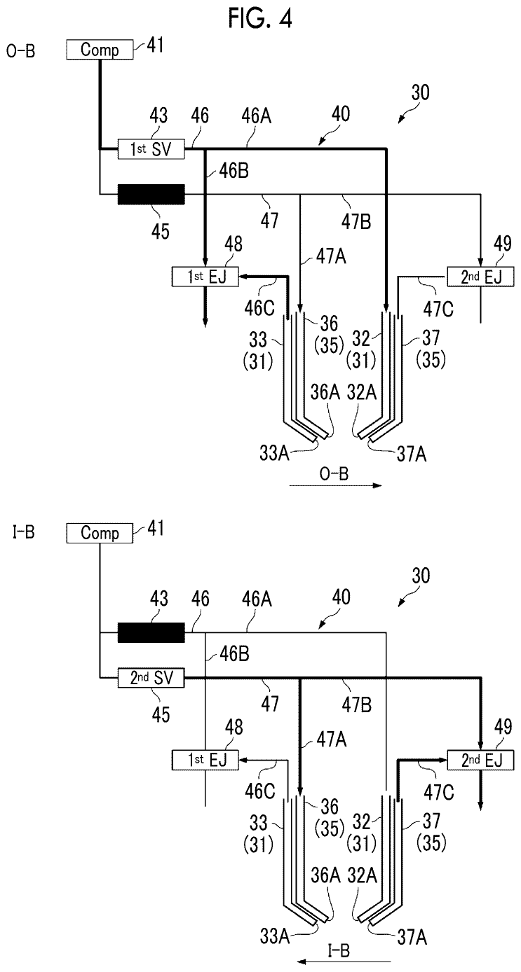

### [Reciprocation: Refer to FIGS. 3 and 4]

The processing of the workpiece W by the laser head 10 while reciprocating will be described with reference to FIGS. 3 and 4.

In FIG. 3, a thick solid line is a processing trajectory MT in the workpiece W in a plan view. The processing is performed while moving the laser head 10 that emits the laser light LB along the processing trajectory MT. Even in a case where the laser light LB is caused to follow the processing trajectory MT only once, the processing of the workpiece W may not be completed. For example, there is a case where the workpiece W is cut along the processing trajectory MT. In this case, in a case where the laser head 10 is moved from a start point SP to an end point EP of the processing trajectory MT (FIG. 3, 1st), the laser head 10 is moved from the end point EP to the start point SP in the reverse direction (FIG. 3, 2nd). This operation is reciprocation. Further, in a case where the irradiation of the laser light LB is required, the laser head 10 is moved from the start point SP to the end point EP of the processing trajectory MT (FIG. 3, 3rd), and then the laser head 10 is moved from the end point EP to the start point SP in the reverse direction (FIG. 3, 4th). In FIG. 3, the trajectory of the reciprocation indicated by the broken line arrow, which also indicates the laser light LB, is drawn by shifting each of the processing trajectories MT, but this is to recognize the reciprocation.

FIG. 4 shows an operation of the scavenging unit 40 in a forward path (O-B) and an operation of the scavenging unit 40 in a backward path (I-B). The open first solenoid valve 43 or the open second solenoid valve 45 is represented by white, and the closed first solenoid valve 43 or the closed second solenoid valve 45 is filled with black. Further, the pipes through which air flows are depicted as thick.

In the forward path (O-B), the first solenoid valve 43 is open, whereas the second solenoid valve 45 is closed. The compressed air from the compressor 41 is discharged from the air supply port 32A through the first air supply pipe 46A and the first air supply nozzle 32. In addition, the compressed air from the compressor 41 passes through the first compressed air supply pipe 46B and the first ejector 48 to depressurize the inside of the first suction pipe 46C and the first suction duct 33, and the surrounding air is suctioned from the suction port 33A. In this way, the product such as the fume by the scavenging in the forward path is recovered.

In the backward path (I-B), the first solenoid valve 43 is closed, whereas the second solenoid valve 45 is opened. The compressed air from the compressor 41 is discharged from the air supply port 36A through the second air supply pipe 47A and the second air supply nozzle 36. In addition, the compressed air from the compressor 41 passes through the second compressed air supply pipe 47B and the second ejector 49, so that the inside of the second suction pipe 47C and the second suction duct 37 is set to a reduced pressure atmosphere, and the air including the surrounding product is suctioned from the suction port 37A. In this way, the product such as the fume by the scavenging in the backward path is recovered.

### Effect

According to the recovery mechanism 30, the first recovery unit 31 and the second recovery unit 35, which are capable of recovering the product such as the fume by scavenging, are provided, and the first recovery unit 31 and the second recovery unit 35 are disposed to face each other. Therefore, it is possible to recover the product such as the fume without changing the disposition of the first recovery unit 31 and the second recovery unit 35 while processing the workpiece W by reciprocating the laser head 10.

The scavenging unit 40 connects the first air supply pipe 46A to the first air supply nozzle 32, interposes the first ejector 48 in the middle of the first compressed air supply pipe 46B, and connects the first ejector 48 and the first suction duct 33 to each other by the first suction pipe 46C. In addition, the scavenging unit 40 connects the second air supply pipe 47A to the second air supply nozzle 36, interposes the second ejector 49 in the middle of the second compressed air supply pipe 47B, and connects the second ejector 49 and the second suction duct 37 to each other by the second suction pipe 47C. Therefore, according to the scavenging unit 40, it is possible to selectively perform the recovery of the product such as the fume by the first recovery unit 31 and the recovery of the product such as the fume by the second recovery unit 35 only by providing one compressor 41.

Although the preferred embodiments have been described, the configurations described in the above embodiments can be selected or appropriately changed to other configurations.

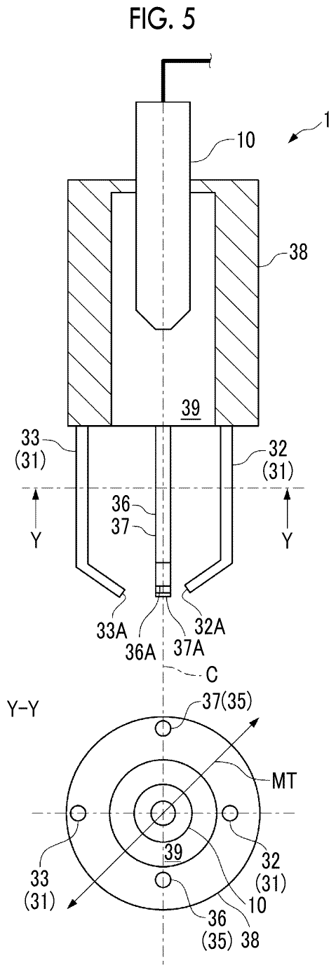

### [First Modification Example: Refer to FIG. 5]

For example, as shown in FIG. 5, the first recovery unit 31 including the first air supply nozzle 32 and the first suction duct 33 and the second recovery unit 35 including the second air supply nozzle 36 and the second suction duct 37 can be disposed with a phase difference. Even with the disposition of the first recovery unit 31 and the second recovery unit 35, the product can be recovered by reciprocating along the processing trajectory MT. Moreover, the first air supply nozzle 32 and the second suction duct 37 are disposed to be spaced from each other in the radial direction, and the first suction duct 33 and the second air supply nozzle 36 are disposed to be spaced from each other. Therefore, even in a case where the opening dimensions of the suction port 33A of the first suction duct 33 and the suction port 37A of the second suction duct 37 are increased, the interference between the first air supply nozzle 32 and the second air supply nozzle 36 can be avoided, and thus the efficiency of recovering the product such as the fume can be improved. In FIG. 5, opening diameters of the suction port 33 A and the suction port 37A are the same as before.

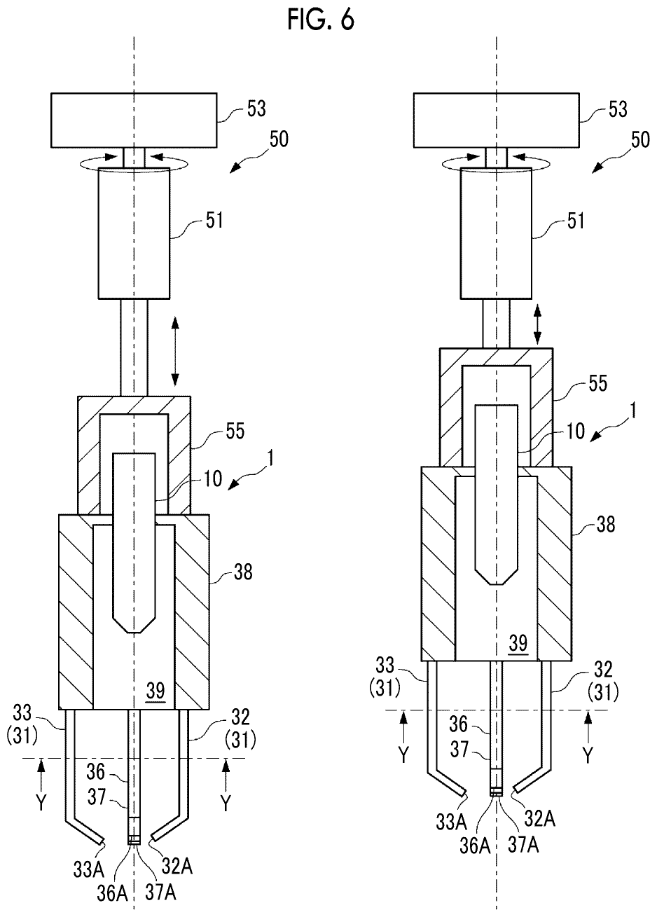

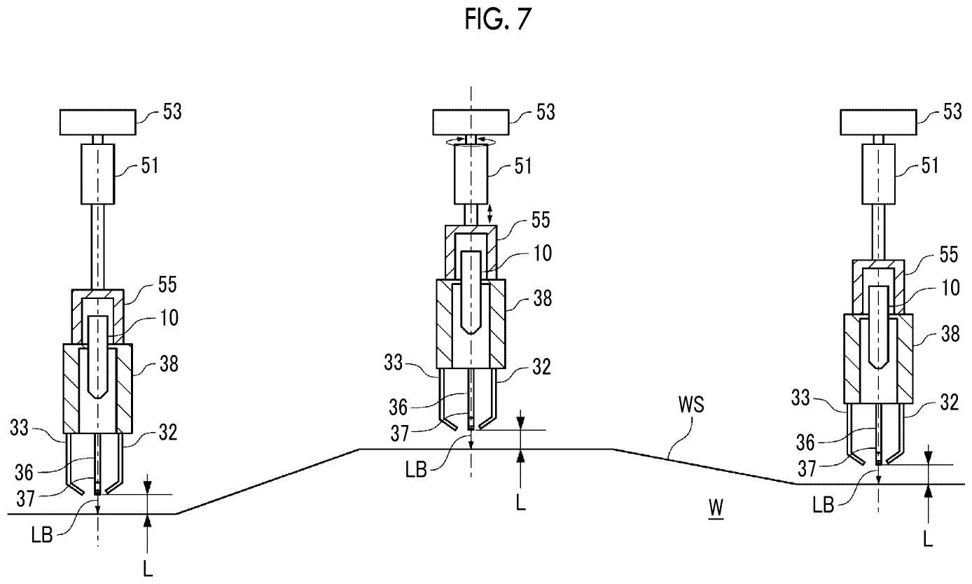

### [Second Modification Example: Refer to FIGS. 6 and 7]

In addition, as shown in FIG. 6, a drive mechanism 50 of the laser head 10 can be provided. The drive mechanism 50 includes, for example, a fluid pressure cylinder 51 that raises and lowers the laser head 10, and an electric motor 53 that rotatably supports the fluid pressure cylinder 51.

For example, a surface WS of the workpiece W has an unevenness, and information regarding the unevenness is acquired. In this case, as shown in FIG. 7, the fluid pressure cylinder 51 is raised and lowered such that a distance L between the laser head 10 and the surface WS of the workpiece W is constant based on the unevenness information. In this case, stable processing of the workpiece W is realized while preventing the first recovery unit 31 and the second recovery unit 35 from interfering with the workpiece W.

Although not shown here, the processing trajectory MT on the surface WS of the workpiece W may vary in a plane direction in which not only a straight portion but also a curved portion or a bent portion is present. In this case, the laser head 10 can be moved in accordance with the processing trajectory MT by rotating and driving not only the fluid pressure cylinder 51 but also the electric motor 53. Even in this case, in a case where the information regarding the processing trajectory MT that varies in the plane direction is acquired, the laser head 10 can be moved along the processing trajectory MT. When the raising and lowering of the fluid pressure cylinder 51 is also taken into consideration, it is possible to accommodate the processing trajectory MT having a three-dimensional shape.

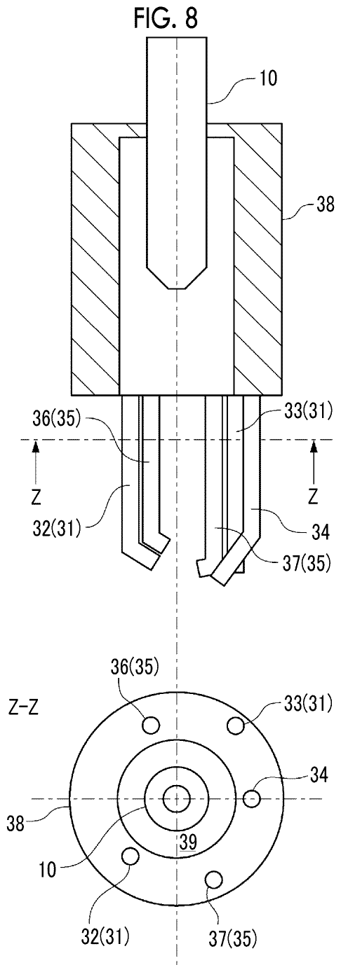

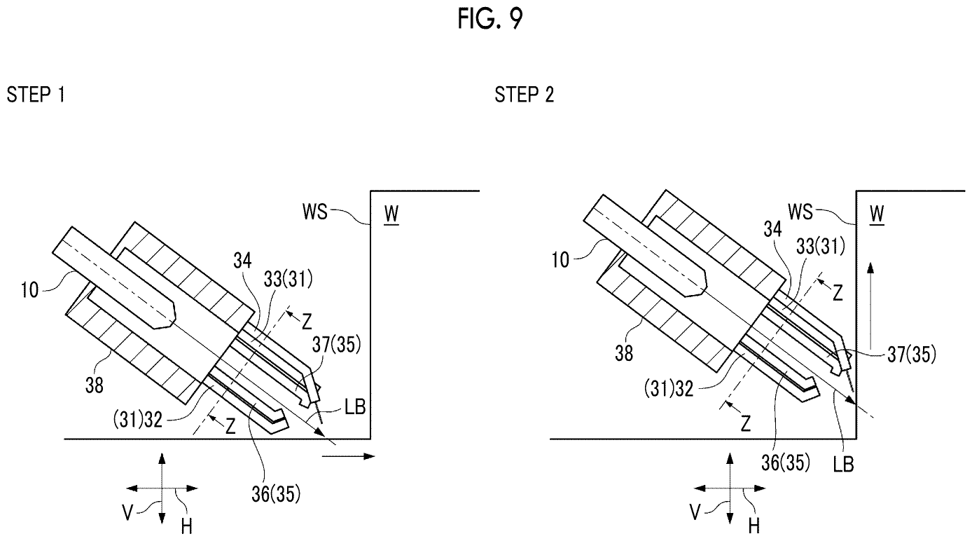

### [Third Modification Example: Refer to FIGS. 8 and 9]

Next, as shown in FIG. 8, in addition to the first recovery unit 31 including the first air supply nozzle 32 and the first suction duct 33 and the second recovery unit 35 including the second air supply nozzle 36 and the second suction duct 37, a third air supply nozzle 34 can be provided. The third air supply nozzle 34 is provided between the first suction duct 33 and the second suction duct 37. The third air supply nozzle 34 having a discharge angle of the compressed air different from those of the first air supply nozzle 32 and the second air supply nozzle 36 is provided for processing in a vertical direction V, whereas the first recovery unit 31 and the second recovery unit 35 are assumed to process the surface WS along a horizontal direction H. The difference in discharge angle is for delivering the compressed air from the third air supply nozzle 34 to the irradiation position of the laser light LB. As a result, the surface WS along the vertical direction V can also be smoothly processed.

In a case where laser processing is performed in the vertical direction V, as shown in STEP1 of FIG. 9, the phase is aligned by the electric motor 53 such that the third air supply nozzle 34 follows the processing trajectory MT. In this case, the laser head 10 is inclined by 45° with respect to the horizontal direction H as an example.

While maintaining the above-described posture, the laser head 10 and the recovery mechanism 30 are advanced toward a corner portion which is an intersection portion between the horizontal direction H and the vertical direction V of the surface WS, and then the processing is performed while moving the laser head 10 and the recovery mechanism 30 upward in the vertical direction V from the corner portion as shown in STEP2 of FIG. 9. In the process of the processing according to the third modification example, the supply of the compressed air from the first air supply nozzle 32 and the second air supply nozzle 36 is not performed, but the suction of the product such as the fume from the first suction duct 33 and the second suction duct 37 is performed. The recovery of the fume or the like can also be performed by an external dust collector in the vicinity of the corner portion. In addition, although STEP2 of FIG. 9 shows only upward processing, even in the third modification example, the laser processing can be performed by repeating the raising and lowering of the laser head 10 and the recovery mechanism 30 in a down direction which is a direction opposite to that of STEP2 of FIG. 9.

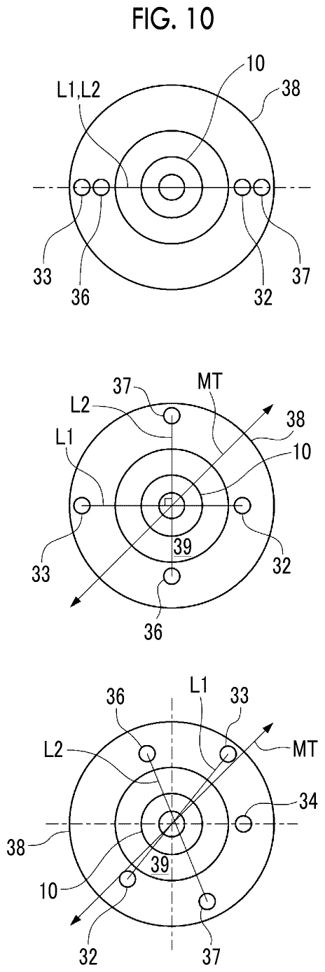

### [Disposition Example of First Recovery Unit and Second Recovery Unit Included in Present Disclosure: FIG. 10]

Three disposition examples are shown in the embodiment and the modification example for the first air supply nozzle 32 and the first suction duct 33 constituting the first recovery unit 31 and the second air supply nozzle 36 and the second suction duct 37 constituting the second recovery unit 35. FIG. 10 shows the three disposition examples. In FIG. 10, the upper part corresponds to the disposition example of the embodiment, the middle part corresponds to the disposition example of the first modification example, and the lower part corresponds to the disposition example of the third modification example.

In the disposition example of the embodiment, a first line segment L1 connecting the first air supply nozzle 32 and the first suction duct 33 and a second line segment L2 connecting the second air supply nozzle 36 and the second suction duct 37 overlap each other. That is, the first air supply nozzle 32, the first suction duct 33, the second air supply nozzle 36, and the second suction duct 37 are arranged in a straight line.

In the disposition example of the first modification example, the first line segment L1 connecting the first air supply nozzle 32 and the first suction duct 33 and the second line segment L2 connecting the second air supply nozzle 36 and the second suction duct 37 intersect each other.

In the disposition example of the embodiment, in a case where the first line segment L1 and the second line segment L2 are reciprocated by the electric motor 53 while aligning the orientations in the direction along the processing trajectory MT, the product can be most efficiently recovered. Meanwhile, in the disposition example of the third modification example, since the suction duct corresponding to the third air supply nozzle 34 is not provided, the efficiency of recovering the product may be inferior to that of the disposition example of the embodiment. However, the product can be sufficiently recovered by suctioning the fume or the like in combination with the external dust collector installed around the surface WS of the workpiece W in the vertical direction V.

As described above, the present invention is not limited to a case where the first line segment L1 and the second line segment L2 overlap each other, and the case where the first line segment L1 and the second line segment L2 intersect each other is also included in the disposition example of the first recovery unit 31 and the second recovery unit 35 according to the present disclosure.

### ADDITIONAL NOTE

<Additional Note 1>
A laser processing device (1) includes a laser head (10) that irradiates a workpiece (W) with laser light (LB), and a recovery mechanism (30) that recovers a product generated by the irradiation with the laser light (LB).
The recovery mechanism (30) includes a first recovery unit (31) that includes a first air supply nozzle (32) that supplies a scavenging gas and a first suction duct (33) that is provided to face the first air supply nozzle (32), and a second recovery unit (35) that includes a second air supply nozzle (36) that supplies the scavenging gas and a second suction duct (37) that is provided to face the second air supply nozzle (36).
<Additional Note 2>
In Additional Note 1, preferably, the first air supply nozzle (32) and the second suction duct (37) are provided to be arranged in a radial direction of a circle centered on an axis (C) of the laser head (10), and the second air supply nozzle (36) and the first suction duct (33) are provided to be arranged in the radial direction.
According to this arrangement, the first air supply nozzle (32), the second suction duct (37), the second air supply nozzle (36), and the first suction duct (33) are arranged in a straight line. In a case where reciprocation is performed along this straight line, the product can be efficiently recovered.
<Additional Note 3>
In Additional Note 1 or 2, preferably, the first air supply nozzle (32) is provided inside the second suction duct (37) in the radial direction, and the second air supply nozzle (36) is provided inside the first suction duct (33) in the radial direction.
According to this arrangement, the scavenging gas discharged from the first air supply nozzle (32) is supplied toward the processed part without being obstructed by the second suction duct (37). In addition, the scavenging gas discharged from the second air supply nozzle (36) is supplied toward the processed part without being obstructed by the first suction duct (33).
<Additional Note 4>
In Additional Notes 1 to 3, preferably, a first line segment (L1) connecting the first air supply nozzle (32) and the first suction duct (33) and a second line segment (L2) connecting the second air supply nozzle (36) and the second suction duct (37) intersect each other.
As described above, even in the arrangement in which the first line segment (L1) and the second line segment (L2) intersect each other, the product can be sufficiently recovered by selecting the processing trajectory (MT).
<additional Note 5>
In Additional Notes 1 to 4, preferably, the recovery mechanism (30) includes a third air supply nozzle (34) that supplies the scavenging gas.
By providing the third air supply nozzle (34), processing can be performed not only in a plane direction but also in a vertical direction.
<Additional Note 6>
In Additional Notes 1 to 5, preferably, the laser head (10) processes the workpiece (W) while reciprocating in a forward path and a backward path, the product is recovered by the first recovery unit (31) in the forward path, and the product is recovered by the second recovery unit (35) in the backward path.
Since the first recovery unit (31) and the second recovery unit (35) are provided, even in a case of processing accompanied by the reciprocation, the product can be recovered without rotating the devices including the laser head (10).
<Additional Note 7>
In Additional Notes 1 to 6, preferably, the recovery mechanism (30) includes a scavenging unit (40) that selectively supplies the scavenging gas to the first recovery unit (31) and the second recovery unit (35) and that suctions the scavenging gas including the product.
The scavenging unit (40) includes a compressor (41) that generates compressed air which is the scavenging gas, an air supply pipe (46A, 47A) that supplies the compressed air to the first air supply nozzle (32) or the second air supply nozzle (36), and a suction pipe (46C, 47C) that connects an ejector (48, 49) generating a reduced pressure atmosphere due to the supplied compressed air and the first suction duct (33) or the second suction duct (37).
According to the scavenging unit (40), the recovery of the product by the first recovery unit (31) and the recovery of the product by the second recovery unit (35) can be selectively performed only by providing one compressor (41).
<Additional Note 8>
In Additional Note 7, preferably, the laser processing device (1) further includes the first solenoid valve (43) and the second solenoid valve (45) that are supplied with the compressed air from the compressor (41) and are each independently opened and closed, in a case where the first solenoid valve (43) is opened and the second solenoid valve (45) is closed, the compressed air is supplied to the first air supply nozzle (32) through the air supply pipe (46A), and a reduced pressure atmosphere acts on the first suction duct (33) through the suction pipe (46C), and in a case where the first solenoid valve (43) is closed and the second solenoid valve (45) is opened, the compressed air is supplied to the second air supply nozzle (36) through the air supply pipe (47A), and a reduced pressure atmosphere acts on the second suction duct (37) through the suction pipe (47C).
By controlling the opening and closing of the first solenoid valve (43) and the second solenoid valve (45), the recovery of the product by the first recovery unit (31) and the recovery of the product by the second recovery unit (35) can be selectively performed.
<Additional Note 9>
In Additional Notes 1 to 8, preferably, the laser processing device (1) further includes a drive mechanism (50) that raises and lowers the laser head (10), the first recovery unit (31), and the second recovery unit (35), and rotates the laser head (10), the first recovery unit (31), and the second recovery unit (35) around an axis (C) of the laser head (10).
By providing the drive mechanism (50), it is possible to realize the processing of the workpiece (W) of which the surface (WS) is changed in a three-dimensional manner.
<Additional Note 10>
In a laser processing method of irradiating a workpiece (W) with laser light (LB) from a laser head (10), the laser processing method includes a first recovery step of supplying a scavenging gas from a first air supply nozzle (32) and suctioning the scavenging gas including a product generated by the irradiation with the laser light (LB) through a first suction duct (33) and a second recovery step of supplying the scavenging gas from a second air supply nozzle (36) and suctioning the scavenging gas including the product with a second suction duct (37), and the first recovery step and the second recovery step are selectively performed.
<Additional Note 11>
In a recovery mechanism (30) that recovers a product such as spatter, fume, and the like, the recovery mechanism (30) includes:
   a first recovery unit (31) that includes a first air supply nozzle (32) that supplies a scavenging gas and a first suction duct (33) that is provided to face the first air supply nozzle (32), and
   a second recovery unit (35) that includes a second air supply nozzle (36) that supplies the scavenging gas and a second suction duct (37) that is provided to face the second air supply nozzle (36).
The recovery mechanism (30) can recover the product such as spatter, fume, and the like generated by a device other than the laser processing device.

### REFERENCE SIGNS LIST

1: Laser processing device
10: Laser head
30: Recovery mechanism
31: First recovery unit
32: First air supply nozzle
32A: Air supply port
32B: Bent portion
33: First suction duct
33A: Suction port
33B: Bent portion
34: Third air supply nozzle
35: Second recovery unit
36: Second air supply nozzle
36A: Air supply port
36B: Bent portion
37: Second suction duct
37A: Suction port
37B: Bent portion
38: Support cylinder
39: Laser passage
40: Scavenging unit
41: Compressor
42: Basic pipe
42A: Branch pipe
42B: Branch pipe
43: First solenoid valve
45: Second solenoid valve
46: First scavenging pipe
46A: First air supply pipe
46B: First compressed air supply pipe
46C: First suction pipe
47: Second scavenging pipe
47A: Second air supply pipe
47B: Second compressed air supply pipe
47C: Second suction pipe
48: First ejector
49: Second ejector
50: Drive mechanism
51: Fluid pressure cylinder
53: Electric motor
LB: Laser light
MT: Processing trajectory
SP: Start point
EP: End point
C: Axis
H: Horizontal direction
V: Vertical direction
W: Workpiece
WS: Surface

1. A laser processing device comprising:
a laser head that irradiates a workpiece with laser light; and
a recovery mechanism that recovers a product generated by the irradiation with the laser light, wherein
the recovery mechanism includes
a first recovery unit that includes a first air supply nozzle that supplies a scavenging gas and a first suction duct that is provided to face the first air supply nozzle, and
a second recovery unit that includes a second air supply nozzle that supplies the scavenging gas and a second suction duct that is provided to face the second air supply nozzle.

2. The laser processing device according to claim 1, wherein
the first air supply nozzle and the second suction duct are provided to be arranged in a radial direction of a circle centered on an axis of the laser head, and
the second air supply nozzle and the first suction duct are provided to be arranged in the radial direction.

3. The laser processing device according to claim 2, wherein
the first air supply nozzle is provided inside the second suction duct in the radial direction, and
the second air supply nozzle is provided inside the first suction duct in the radial direction.

4. The laser processing device according to claim 1, wherein
a first line segment connecting the first air supply nozzle and the first suction duct, and
a second line segment connecting the second air supply nozzle and the second suction duct intersect each other.

5. The laser processing device according to claim 2, wherein the recovery mechanism includes a third air supply nozzle that supplies the scavenging gas.

6. The laser processing device according to claim 1, wherein
the laser head processes the workpiece while reciprocating in a forward path and a backward path,
the product is recovered by the first recovery unit in the forward path, and
the product is recovered by the second recovery unit in the backward path.

7. The laser processing device according to claim 1, wherein
the recovery mechanism supplies selectively the scavenging gas to the first recovery unit and the second recovery unit and includes a scavenging unit that suctions the scavenging gas including the product, and
the scavenging unit includes
a compressor that generates compressed air which is the scavenging gas,
an air supply pipe that supplies the compressed air to the first air supply nozzle or the second air supply nozzle,
an ejector that generates a reduced pressure atmosphere by supplying the compressed air, and
a suction pipe that connects the ejector to the first suction duct or the second suction duct.

8. The laser processing device according to claim 7, further comprising
a first solenoid valve and a second solenoid valve that are supplied with the compressed air from the compressor and are each independently opened and closed, wherein
in a case where the first solenoid valve is opened and the second solenoid valve is closed, the compressed air is supplied to the first air supply nozzle through the air supply pipe, and a reduced pressure atmosphere acts on the first suction duct through the suction pipe, and
in a case where the first solenoid valve is closed and the second solenoid valve is opened, the compressed air is supplied to the second air supply nozzle through the air supply pipe, and a reduced pressure atmosphere acts on the second suction duct through the suction pipe.

9. The laser processing device according to claim 1, further comprising a drive mechanism that raises and lowers the laser head, the first recovery unit, and the second recovery unit and rotates the laser head, the first recovery unit, the second recovery unit around an axis of the laser head.

10. A laser processing method of irradiating a workpiece with laser light from a laser head, the laser processing method comprising:
a first recovery step of supplying a scavenging gas from a first air supply nozzle and suctioning the scavenging gas including a product generated by the irradiation with the laser light through a first suction duct; and
a second recovery step of supplying the scavenging gas from a second air supply nozzle and suctioning the scavenging gas including the product through a second suction duct, wherein the first recovery step and the second recovery step are selectively performed.

11. A recovery mechanism that recovers a product such as spatter, fume, and the like, the recovery mechanism comprising:
a first recovery unit that includes a first air supply nozzle that supplies a scavenging gas and a first suction duct that is provided to face the first air supply nozzle; and
a second recovery unit that includes a second air supply nozzle that supplies the scavenging gas and a second suction duct that is provided to face the second air supply nozzle.

12. The laser processing device according to claim 4, wherein the recovery mechanism includes a third air supply nozzle that supplies the scavenging gas.
